(19) United States
(12) Patent Application Publication
(10) Pub. No.: US 2011/0110543 A1
(43) Pub. Date: May 12, 2011

(54) Headphone and stereo headphone

(75) Inventors: Kazunori Ishizaka, Tokyo-To (JP); Takuya Arimoto, Tokyo-To (JP)

(73) Assignee: Victor Company of Japan, Ltd., Yokohama-shi (JP)

(21) Appl. No.: 12/927,004

(22) Filed: Nov. 3, 2010

(30) Foreign Application Priority Data
Nov. 6, 2009 (JP) JP 2009-254850

(51) Int. Cl. H04R 5/02; H04R 1/10

(52) U.S. Cl. 381/309; 381/370

(57) ABSTRACT

A headphone housing has a first and a second summit in cross section. A sound emitter protrudes from the housing in side section. In the cross section, the first summit protrudes as being away from a point of intersection of an axis line of the sound emitter, that is horizontal and vertical to the side and cross sections, respectively, and a first straight line going through a cord guide located in an outer edge of the cross section, in a first side with respect to the first line and in a second side far from the cord guide with respect to a second straight line going through the point and intersecting with the first line. The second summit protrudes as being away from the point in the second side and in a third side, the opposite of the first side with respect to the first line.

### CROSS-REFERENCE TO RELATED APPLICATIONS

This application is based on and claims the benefit of priority from the prior Japanese Patent Application No. 2009-254850 filed on Nov. 6, 2009, the entire contents of which is incorporated herein by reference.

### BACKGROUND OF THE INVENTION

The present invention relates to a headphone and a stereo headphone.

In the following description, unless otherwise stated, the term “headphone” is defined as a single headphone to be attached to either of the left and right ears of a user whereas the term “stereo headphone” is defined as having a set of headphones to be attached to the left and right ears of a user. In both types, the number of channels of audio signals to be input or output is not limited to a particular number.

The widespread of portable music players has made the market of headphones active with a variety of improvements to the shape and design of headphones to be connected to the players.

The stereo headphone is divided into several types in accordance with how to attach the stereo headphone to a user's head. Most known stereo headphones are: an overhead type equipped with a headband that links left and right headphones and resting on user's head; and an inner-ear type equipped with separate left and right headphones to be fit in the antihelixes of user's ears.

One type of the inner-ear type already commercialized is so-called a canal type equipped with a sound emitter protruding from a main body and an ear piece attached to the tip of the sound emitter. In use, the sound emitter is inserted into the ear channel of a user's ear, together with the ear piece.

The headphone is divided into two types depending on which direction a cord is running from a main body when the headphone is attached to the antihelix of a user's ear. In detail, the headphone is divided into a first type in which a cord is running in a forward diagonally lower direction from a main body fit in the antihelix and a second type in which a cord is running in a forward diagonally upper direction from a main body fit in the antihelix.

In general, the inner-ear type headphone can be divided into the first and second types no matter whether it is the canal type or not.

In the following description, the first and second types are referred to as a lower running type and an upper running type, respectively. Moreover, in the following description, the direction in which a cord is running from a main body is explained with terms “a cord lower-running mode” and “a cord upper-running mode” with respect to the first and second types, respectively.

Examples concerning the cord lower- and upper-running modes can be found in Japanese Un-Examined Patent Publication Nos. 2009-044429 and 2001-258087, respectively.

The lower running type has been popular for headphones, featuring easy and natural attachment. Compared to the lower running type, the upper running type is little bit troublesome for attachment because a cord once runs from a main body fit in the antihelix to the front side of the head and is turned to the rear side of the head through the upper side. In spite of that, the upper running type is advantageous in that the main body is hardly detached from the antihelix while a user is exercising or the cord is hooked by something. It is also advantageous in that a rubbing sound of the cord is hardly heard because the sound is absorbed by the antihelix.

Known headphones are either the lower running type or the upper running type. Thus, users have to buy both types if he or she wants to use them depending on the situations.

Some headphones of the lower running type can be fit in the antihelix in a manner that a cord runs like the upper running type. However, users feel not so good while attaching the headphones.

There are demands from users that they can freely select either the lower or upper running type depending on the situations or without buying both types of headphones.

### SUMMARY OF THE INVENTION

A purpose of the present invention is to provide a headphone and a stereo headphone available for both of the cord lower- and upper-running modes, having a main body which can be smoothly fit in the antihelix of a user's ear.

The present invention provides a headphone comprising: a main body having a housing and a tube-like sound-emitting portion formed at a first section of the housing and to which an ear piece is detachably attached; a speaker unit provided at the housing or the sound-emitting portion; and a cord running outside from a cord guiding portion provided at a side section of the housing, wherein, when the main body is viewed from a second section that is opposite of the first section, the housing has a first summit and a second summit, the first summit protrudes in a first direction away from a point of intersection that is an intersection of a center axis line that goes through the sound-emitting portion and a first straight line that goes through the cord guiding portion and intersects with the center axis, the first direction being at one side with respect to the first straight line and another side far from the cord guiding portion with respect to a second straight line that goes through the point of intersection and is perpendicular to the first straight line, and the second summit protrudes in a second direction away from the point of intersection, the second direction being at another side that is opposite of the one side with respect to the first straight line and another side far from the cord guiding portion with respect to the second straight line.

Moreover, the present invention provides a headphone comprising: a main body including a housing having a first side, an opposing second side, a cross section at the second side, and a side section that is vertical to the cross section and is extending between the first and second sides, the main body further including a sound-emitting portion provided at the first side and to which an ear piece is detachably attached, the sound-emitting portion having a center axis line that goes through the sound-emitting portion between the first and second sides and that is horizontal to the side section and vertical to the cross section; a speaker unit provided at the housing or the sound-emitting portion; and a cord guiding portion provided at the side section of the housing between the first and second sides and located at an outer edge of the cross section when the main body is viewed from the second side, a cord running outside of the housing from the cord guiding portion, wherein, when the main body is viewed from the second side, the housing has at least a first summit and a second summit in the cross section, and the housing also has a point of intersection, a first straight line, and a second straight line, each being located in the cross section, wherein, the point of intersection is an intersection of the center axis line and the first straight line that goes through the cord guiding portion in the cross section, and the second straight line goes through the point of intersection and intersects with the first straight line, wherein, the first summit protrudes in a direction away from the point of intersection in a third side that is located in the cross section with respect to the first straight line and also in a fourth side that is located in the cross section and is the opposite of the cord guiding portion with respect to the second straight line, and the second summit protrudes in a direction away from the point of intersection in the fourth side and also in a fifth side that is located in the cross section and is the opposite of the third side with respect to the first straight line.

Moreover, the present invention provides a stereo headphone comprising: a first headphone to be attached to a left ear of a user; and a second headphone to be attached to a right ear of the user, wherein each of the first and second headphones includes; a main body having a housing with a first side, an opposing second side, a cross section at the second side, and a side section that is vertical to the cross section and is extending between the first and second sides, the main body further having a sound-emitting portion provided at the first side and to which an ear piece is detachably attached, the sound-emitting portion having a center axis line that goes through the sound-emitting portion between the first and second sides and that is horizontal to the side section and vertical to the cross section; a speaker unit provided at the housing or the sound-emitting portion; and a cord guiding portion provided at the side section of the housing between the first and second sides and located at an outer edge of the cross section when the main body is viewed from the second side, a cord running outside of the housing from the cord guiding portion, wherein, when the main body is viewed from the second side, the housing has at least a first summit and a second summit in the cross section, and the housing also has a point of intersection, a first straight line, and a second straight line, each being located in the cross section, wherein, the point of intersection is an intersection of the center axis line and the first straight line that goes through the cord guiding portion in the cross section, and the second straight line goes through the point of intersection and intersects with the first straight line, wherein, the first summit protrudes in a direction away from the point of intersection in a third side that is located in the cross section with respect to the first straight line and also in a fourth side that is located in the cross section and is the opposite of the cord guiding portion with respect to the second straight line, and the second summit protrudes in a direction away from the point of intersection in the fourth side and also in a fifth side that is located in the cross section and is the opposite of the third side with respect to the first straight line.

### BRIEF DESCRIPTION OF DRAWINGS

FIG. 1 is a perspective view showing an appearance of a headphone at the rear side, according to a preferred embodiment of the present invention;

FIG. 2 is sectional view of the headphone according to the embodiment of the present invention;

FIG. 3 is a rear view of the headphone according to the embodiment of the present invention;

FIG. 4 is a side view of the headphone according to the embodiment of the present invention;

FIG. 5 is a top view of the headphone according to the embodiment of the present invention;

FIG. 6 is a view showing a stereo headphone according to a preferred embodiment of the present invention;

FIG. 7 is a view (constituted by four separated views) of the headphone according to the embodiment of the present invention, attached to the left or right ear;

FIG. 8 is view showing the internal structure of the pinna of the left ear;

FIG. 9 is a view (constituted by three separated views) of the headphone according to the embodiment of the present invention, in simplified form with indication of a displayed content;

FIG. 10 is a view (constituted by three separated views) of the headphone according to the embodiment of the present invention, in simplified form with indication of a displayed content; and

FIG. 11 is a view illustrating a structural feature of the headphone according to the embodiment of the present invention.

### DETAILED DESCRIPTION OF PREFERRED EMBODIMENTS

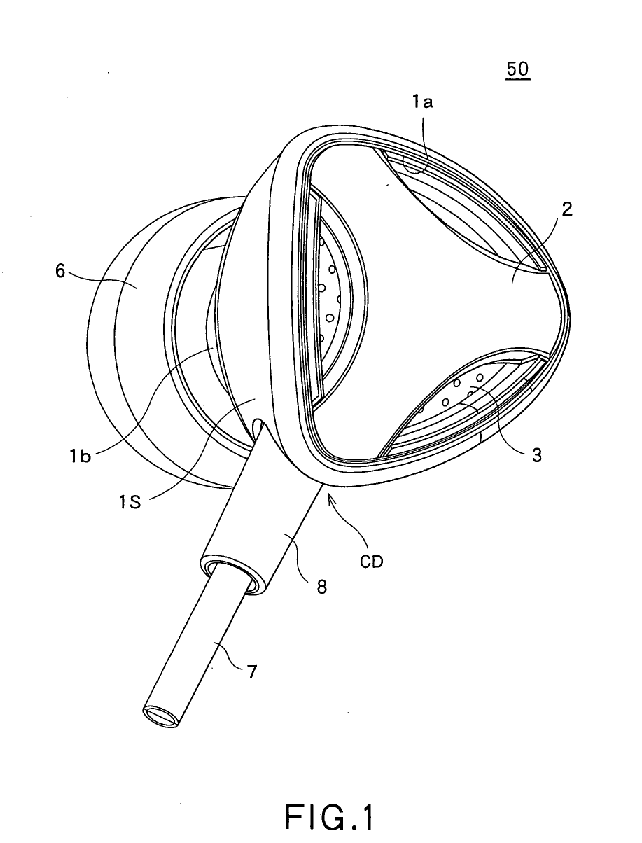

Preferred embodiments according to the present invention will be described with reference to FIGS. 1 to 11.

A headphone 50, an embodiment of the present invention, is a canal type headphone.

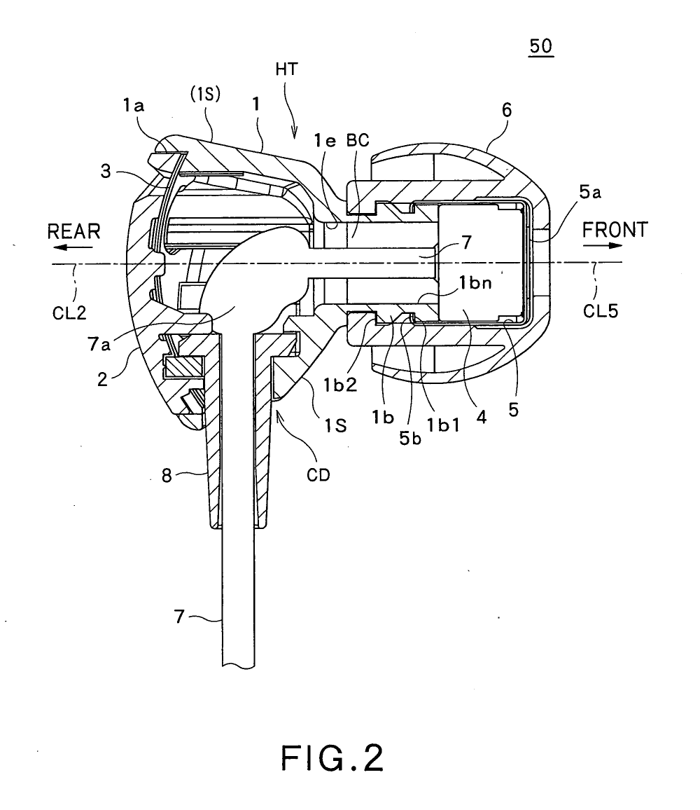

As shown in FIGS. 1 and 2, the headphone 50 is equipped with: a main body HT having a housing 1 formed with an open-end portion 1a at the rear side and a through hole 1e at the front side, and a cylindrical sound-emitting portion 1b having a hole 1bn formed so as to protrude in the front side of the housing 1 and to communicate with the through hole 1e; an ornament 2 attached to the housing 1 so as to cover a portion of the opening of the open-end portion 1a with a mesh 3 for sound quality adjustments; and a speaker unit 4 provided at the tip of the cylindrical sound-emitting portion 1b formed at the front side of the housing 1.

The housing 1 is formed into roughly a hollow quadrilateral-pyramid trapezoid shape with a center axis line CL2 passing therethrough.

The sound-emitting portion 1b is formed like a tube with a center axis line CL5 passing therethrough and coaxial with the center axis line CL2. The sound-emitting portion 1b is formed into a cylindrical shape in the embodiment.

The center axis lines CL2 and CL5 may, however, not be coaxial with each other but be parallel or inclined to each other as long as smooth attachment is achieved in two modes which will be described later.

The speaker unit 4 is fixed to the sound-emitting portion 1b with a cup-shaped unit holder 5 having a plurality of small holes 5a provided on the bottom so that the sounds from the speaker unit 4 are given off the outside through the small holes 5a. In detail, the speaker unit 4 is installed in the unit holder 5 and is pressed against the tip of the sound-emitting portion 1b. Under this state, an edge portion 5b of the unit holder 5 at the open end side is crimped in a circumferential groove 1b1 formed around the sound-emitting portion 1b.

The sound-emitting portion 1b also has another circumferential groove 1b2 formed therearound. An ear piece 6 made of rubber, for example, is elastically engaged with the circumferential groove 1b2 so that the ear piece 6 is detachable to the headphone 50.

Created inside the sound-emitting portion 1b and the housing 1 at the rear side of the speaker unit 4 is a space so-called a back cavity BC.

Running into the back cavity BC is a cord 7, one end portion thereof being connected to the speaker unit 4 so as to carry an audio signal to the speaker unit 4, another end portion thereof running out through a cord guiding portion CD provided at a side face 1s of the housing 1 while supported by or covered with a bushing 8.

The swell of the cord 7 shown in the back cavity BC in FIG. 2 indicates a ball portion 7a for prevention of falling-off.

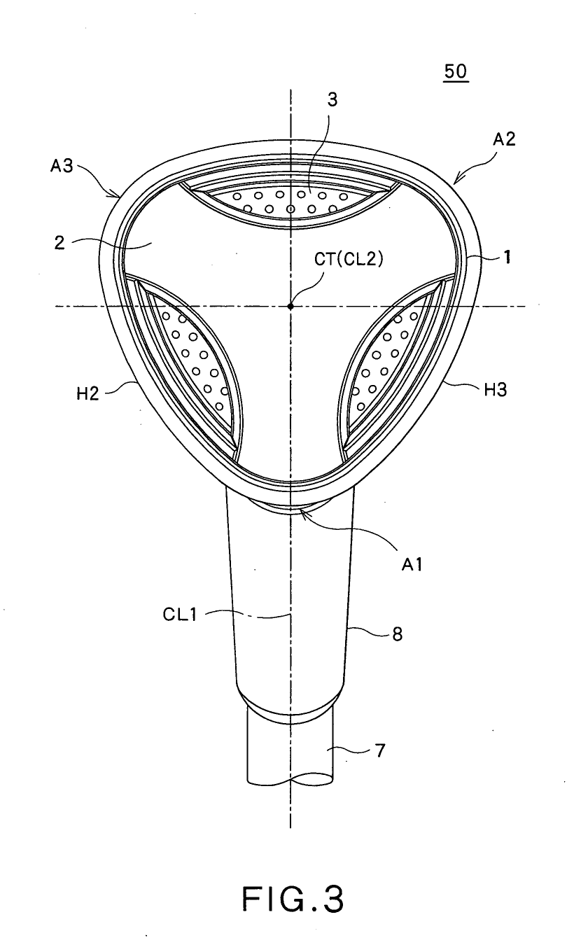

Described next is the outer shape of the housing 1 with respect to FIGS. 3 to 5.

As shown in FIG. 3, the housing 1 has roughly a triangle shape with three summits when viewed from the rear side in FIG. 2. FIG. 3 shows three summits A1, A2 and A3 in the counterclockwise direction. The bushing 8 is provided at the summit A1 and the cord 7 is running from the summit A1.

Moreover, as shown in FIG. 3, the housing 1 is formed in line-symmetric in left and right with respect, at least, to a center line CL1 in the running direction of the cord 7. In other words, in FIG. 3, the housing 1 is formed into roughly an isosceles triangle having the summit A1 as a vertex.

This roughly isosceles triangle is, preferably, roughly an equilateral triangle having a center CT on the center line CL1 with an equal distance from the summits A1, A2 and A3, as shown in FIG. 3.

The roughly isosceles and equilateral triangles preferably have outwardly curved sides, as shown in FIG. 3. The sides may, however, be inwardly curved sides, a combination of outwardly and inwardly curved sides or straight sides.

The summits A1, A2 and A3 are preferably formed in a gently curved shape, as shown in FIG. 3, although they may be sharp edges.

In the embodiment, the center CT is located on the center axis line CL5 shown in FIG. 2.

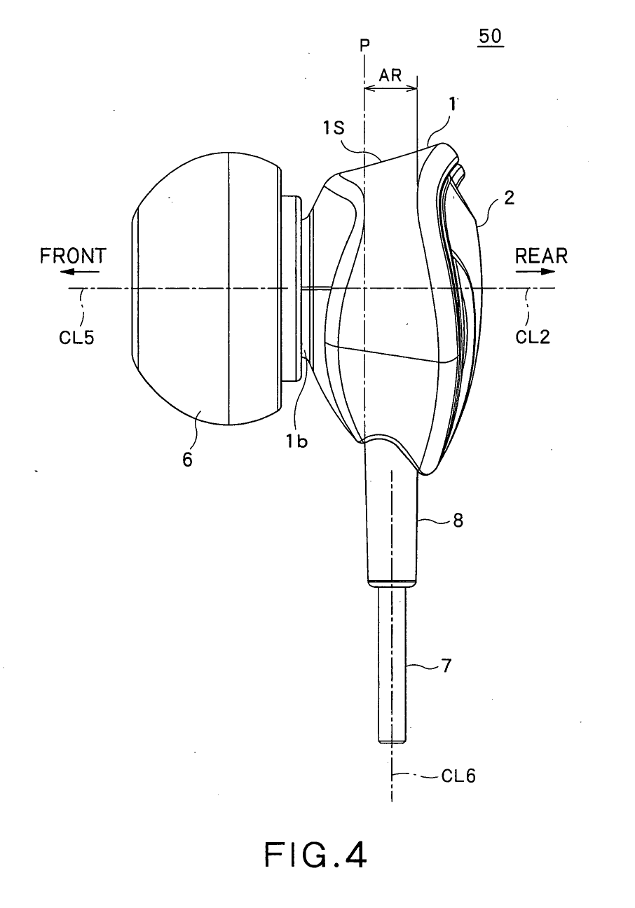

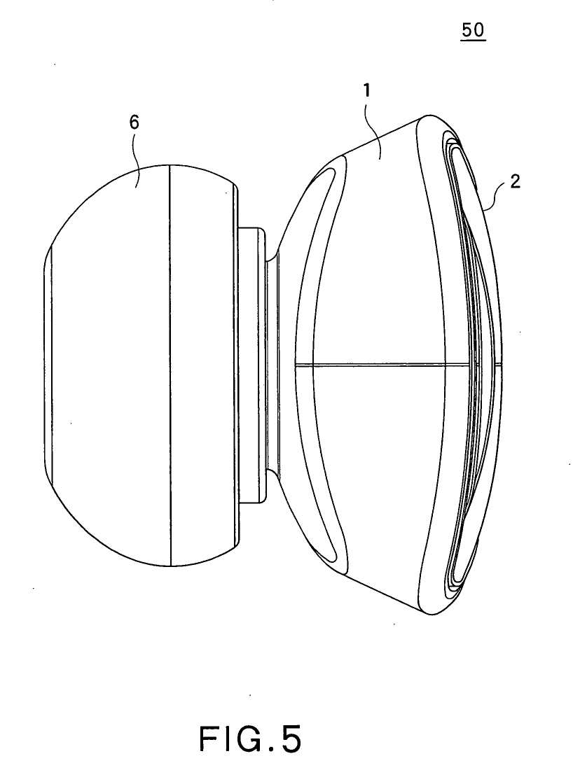

As shown in FIGS. 4 and 5, the housing 1 is formed in a shape such that it becomes narrower towards the front side from the open-end portion 1a (FIG. 2).

Moreover, in FIG. 4, the housing 1 has roughly a triangular shape in cross section with the summits A1 to A3 (FIG. 3) from the open-end portion 1a to a position P on the way towards the front side. In other wards, the housing 1 has roughly a triangular shape in cross section in a zone AR in the direction of the center axis line CL2 in the side face 1s (FIG. 2) of the housing 1.

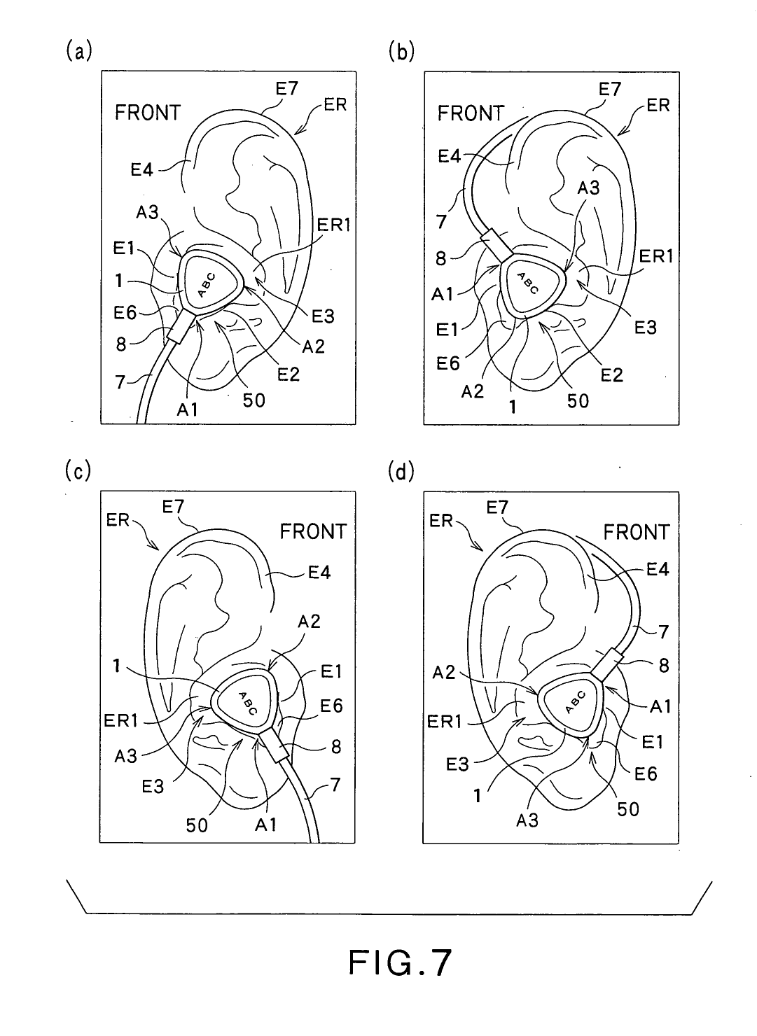

Although attachment of the headphone 50 to the antihelix of a user's ear will be described later, the zone AR is set to a location where the summits A2 and A3 are in contact with an inner wall ER1 (FIG. 7) of the user's ear while the housing 1 is installed in the concha E3 (FIG. 7) of the user's ear. The zone AR may be set in the range from 4 mm to 6 mm.

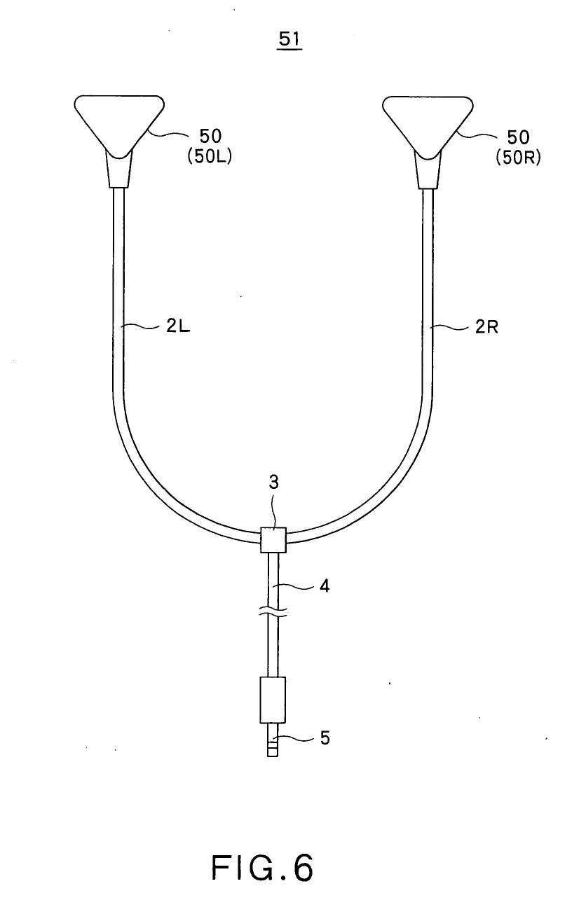

Described next with reference to FIGS. 6 to 8 is a stereo headphone 51 equipped with a pair of headphones 50 for the left and right ears and fit into the pinnas of user's ears.

As shown in FIG. 6, the stereo headphone 51 is equipped with a headphone 50L for the left ear and a headphone 50R for the right ear. The headphones 50L and 50R (each having the same structure as the headphone 50) are preferably identical to each other for the left and right ears but can be distinguished from each other by the orientation of marking or the structural feature (protrusion) or the like based on the universal design.

In addition to the headphones 50L and 50R, the stereo headphone 51 is equipped with: sub-cords 2L and 2R that run from the headphones 50L and 50R, respectively; a junction unit 3 that couples the cords 2L and 2R together; a main cord 4 having the unit 3 at one end; and a plug 5 provided to the main cord 4 at the other end and connected to external audio equipment.

FIG. 7 shows each of the headphones 50L and 50R of the stereo headphone 51 fit into a pinna ER of each user's ear, in which (a) and (b) show the left ear whereas (c) and (d) show the right ear. In detail, (a) and (c) of FIG. 7 show that the sub-cord 2R runs in a forward diagonally lower direction (the cord lower-running mode), whereas (b) and (d) of FIG. 7 show that the sub-cord 2R runs in a forward diagonally upper direction (the cord upper-running mode).

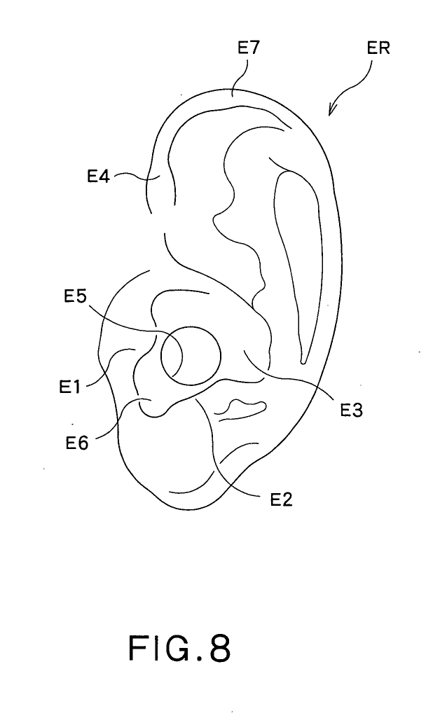

FIG. 8 shows the internal structure of the pinna ER of the left ear, having a tragus E1, an antitragus E2, a concha E3, a crus helicis E4, an ear channel E5, an incisura intetragica E6, and a helix E7.

Described below is the headphone SOL of the stereo headphone 51 attached to the left ear, with respect to (a) and (b) of FIG. 7 and FIG. 8.

The headphone 50L is attached inside the pinna ER in such a manner that the housing 1 is fit in the concha E3, with the ear piece 6 being inserted into the ear channel E5.

In the cord lower-running mode, as shown in (a) of FIG. 7, the housing 1 takes a posture in which the cord 7 (the sub-cord 2L of the headphone 50L) runs in a forward diagonally lower direction, with the bushing 8 located in the incisura intetragica E6.

In this posture, the summit A1 (FIG. 3) of the housing 1 is located at the incisura intetragica E6. Moreover, in this posture, the summit A2 of the housing 1 is in contact with an inner wall ER1 located behind the concha E3, with one side H2 (that faces the summit A2 in FIG. 3) of roughly an isosceles triangle shape of the housing 1 being in contact with the tragus E1. Accordingly, the housing 1 is stably held between a wall located in front of the concha E3 and the inner wall ER1.

In contrast, as shown in (b) of FIG. 7, in the cord upper-running mode, the housing 1 takes a posture in which the cord 7 (the sub-cord 2L) runs in a forward diagonally upper direction, with the bushing 8 located closer to the crus helicis E4. The cord 7 runs from the head front side of the crus helicis E4 to the rear side of the helix E7 via the head upper side.

In this posture, the summit A2 (FIG. 3) of the housing 1 is located at the incisura intetragica E6. Moreover, in this posture, the summit A3 of the housing 1 is in contact with the inner wall ER1, with another side H3 (that faces the summit A3 in FIG. 3) of roughly an isosceles triangle shape of the housing 1 being in contact with the tragus E1. Accordingly, the housing 1 is stably held between the wall located in front of the concha E3 and the inner wall ER1.

Described next is the headphone 50R of the stereo headphone 51 attached to the right ear, with respect to (c) and (d) of FIG. 7 and FIG. 8. The right ear has an almost symmetrical structure with the left ear, so that the same reference signs in FIG. 8 are used for the right ear concerning the common parts of the pinna ER of the left and right ears.

The headphone 50R is attached inside the pinna ER in such a manner that the housing 1 (FIG. 2) is fit in the concha E3, with the ear piece 6 being inserted into the ear channel E5.

In the cord lower-running mode, as shown in (c) of FIG. 7, the housing 1 takes a posture in which the cord 7 (the sub-cord 2R) runs in a forward diagonally lower direction, with the bushing 8 located in the incisura intetragica E6.

In this posture, the summit A1 (FIG. 3) of the housing 1 is located at the incisura intetragica E6. Moreover, in this posture, the summit A3 of the housing 1 is in contact with the inner wall ER1, with the side H3 (FIG. 3) of the housing 1 being in contact with the tragus E1. Accordingly, the housing 1 is stably held between the wall located in front of the concha E3 and the inner wall ER1.

In contrast, as shown in (d) of FIG. 7, in the cord upper-running mode, the housing 1 takes a posture in which the cord 7 (the sub-cord 2R) runs in a forward diagonally upper direction, with the bushing 8 located closer to the crus helicis E4. The cord 7 runs from the head front side of the crus helicis E4 to the rear side of the helix E7 via the head upper side.

In this posture, the summit A3 (FIG. 3) of the housing 1 is located at the incisura intetragica E6. Moreover, in this posture, the summit A2 of the housing 1 is in contact with the inner wall ER1, with the side H2 (FIG. 3) of the housing 1 being in contact with the tragus E1. Accordingly, the housing 1 is stably held between the wall located in front of the concha E3 and the inner wall ER1.

The cord lower- and upper-running modes described above with respect to (a) and (c), and (b) and (d) of FIG. 7, respectively, for the headphones 50L and 50R of the stereo headphone 51 are also applied to the headphone 50.

As described in detail, when the headphones 50L (50) is attached to the left ear, in the cord lower-running mode, the summit A2 of the housing 1 is in contact with the inner wall ER1 located in the opposite of the tragus E1 with respect to the ear channel E5 located therebetween, whereas, in the cord upper-running mode, the summit A3 of the housing 1 is in contact with the inner wall ER1. In contrast, when the headphones 50R (50) is attached to the right ear, in the cord lower-running mode, the summit A3 in contact with the inner wall ER1, whereas, in the cord upper-running mode, the summit A2 is in contact with the inner wall ER1.

It is most preferable for the cord guiding portion CD (FIG. 2) to be located at the summit A1 of the housing 1, as shown in FIG. 3, because the cord 7 (2L, 2R) is located in the incisura intetragica E6 in the cord lower-running mode, whereas located closer to the crus helicis E4 in the cord upper-running mode.

As described above, the headphone 50 can be comfortably fit in the pinna ER of the left or right ear in the cord lower-running mode in which the cord 7 runs in a forward diagonally lower direction and also in the cord upper-running mode in which the cord 7 runs in a forward diagonally upper direction. The same is applied to the stereo headphone 51 having the cords 2L and 2R.

Moreover, the stereo headphone 51 equipped with the headphones 50L and 50R can be comfortably attached to the left and right ears in both of the cord lower- and upper-running modes, even though the headphones 50L and 50R have the same outer shape.

Described next is the headphone 50 (50L, 50R) having a mark, such as a logo or another design thereon.

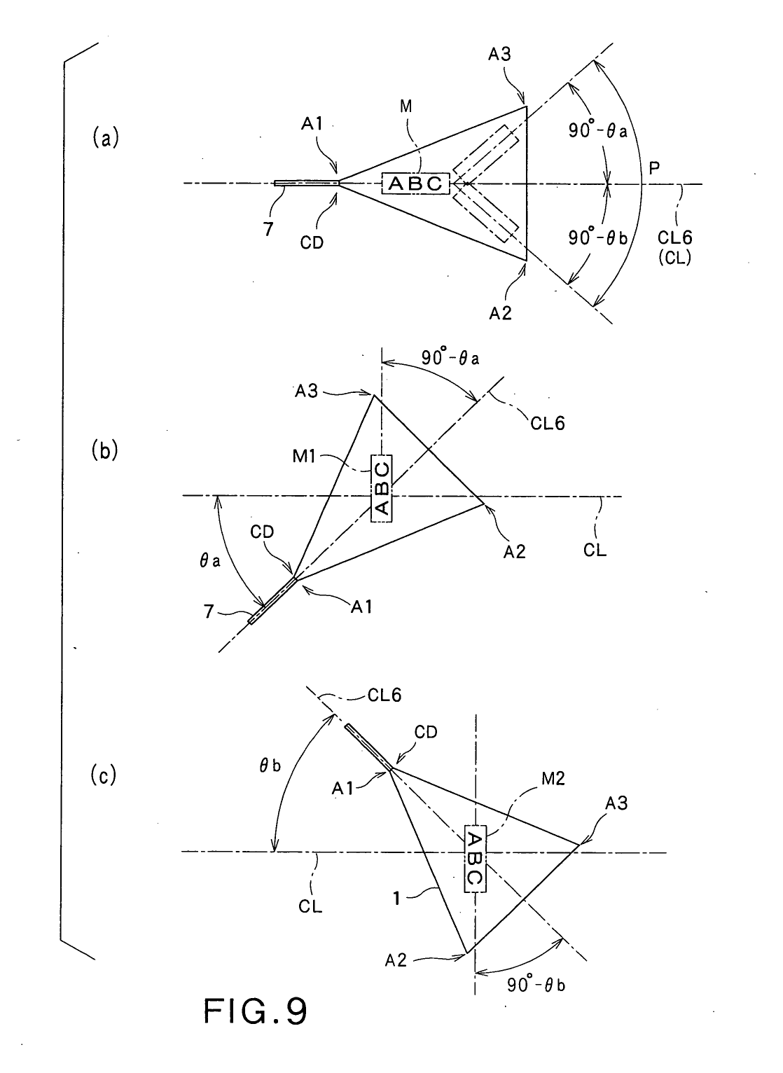

Shown in (a), (b) and (c) of FIG. 9 in simplified form is the housing 1 of the headphone 50 (50L) to be attached to the left ear, with indication of the direction in which the cord 7 (2L) is running. In detail, shown in (a) of FIG. 9 is a posture of the housing 1 in which the cord 7 (2L) lying on an axis line CL6 runs in a direction of a horizontal line CL of the sheet of the drawing. Shown in (b) of FIG. 9 is another posture of the housing 1 in which the cord 7 (2L) lying on the axis line CL6 runs in a forward diagonally lower direction (or the counterclockwise direction) with an angle θa (such as, 60 degrees) with respect to the horizontal line CL, in the cord lower-running mode. Shown in (c) of FIG. 9 is still another posture of the housing 1 in which the cord 7 (2L) lying on the axis line CL6 runs in a forward diagonally upper direction (or the clockwise direction) with an angle θb (such as, 60 degrees) with respect to the horizontal line CL, in the cord upper-running mode.

Displayed on the housing 1 is a model number, a name of product, a logo of a maker, etc. of the headphone 50 or the stereo headphone 51.

Actually, what is displayed on the housing 1 is a string of characters such as numerals and signs, a mark or a design, which is referred to as a displayed content M in the following description.

There is a suitable direction or posture for the displayed content M to be read or recognized easily. For example, when the displayed content M is a string of characters, there is a suitable direction in which the characters such as the alphabets can be read easily by a user when the user sits or stands upright. When the displayed content M is a design such as a logo, there is a suitable posture in which a log can easily be recognized.

In such a case described above, the displayed content M is preferably displayed on the axis line CL6 or in parallel with the line CL6. In (a) of FIG. 9, the displayed content M is a string of characters “ABC” aligned on the axis line CL6. Such a string of characters aligned on the axis line CL6 can be easily recognized by a user in both of the cord lower- and upper-running modes because the characters do not turn upside down although they are inclined.

In order for the displayed content M not to be upside down, the content M may be formed on the housing 1 as being inclined by an angle up to (90°−θa) in the counterclockwise direction from the axis line CL6 in the cord lower-running mode whereas up to (90°−θb) in the clockwise direction from the axis line CL6 in the cord upper-running mode. The displayed content M may thus be inclined within an angle range P from (90°−θa) in the counterclockwise direction to (90°−θb) in the clockwise direction, with respect to the axis line CL6, as shown in (a) of FIG. 9.

Shown in (b) of FIG. 9 is a displayed content M1 formed on the housing 1 as being inclined by the angle (90°−θa) in the counterclockwise direction from the axis line CL6. Shown in (c) of FIG. 9 is a displayed content M2 formed on the housing 1 as being inclined by the angle (90°−θb) in the clockwise direction from the axis line CL6.

In contrast, the headphone 50 (50R) to be attached to the right ear has a posture with the cord 7 (2R) and the housing 1 that are reversed left and right with respect to FIG. 9 when it is attached to the right ear.

Therefore, if the displayed content M is a string of characters “ABC”, the characters are displayed on the housing 1 from “A” to “C” from the opposite side of the cord guiding portion CD of the headphone 50 (50R) for the right ear, contrary to the characters “ABC” displayed on the housing 1 from “A” to “C” from the cord guiding portion CD side of the headphone 50 (50L) for the left ear.

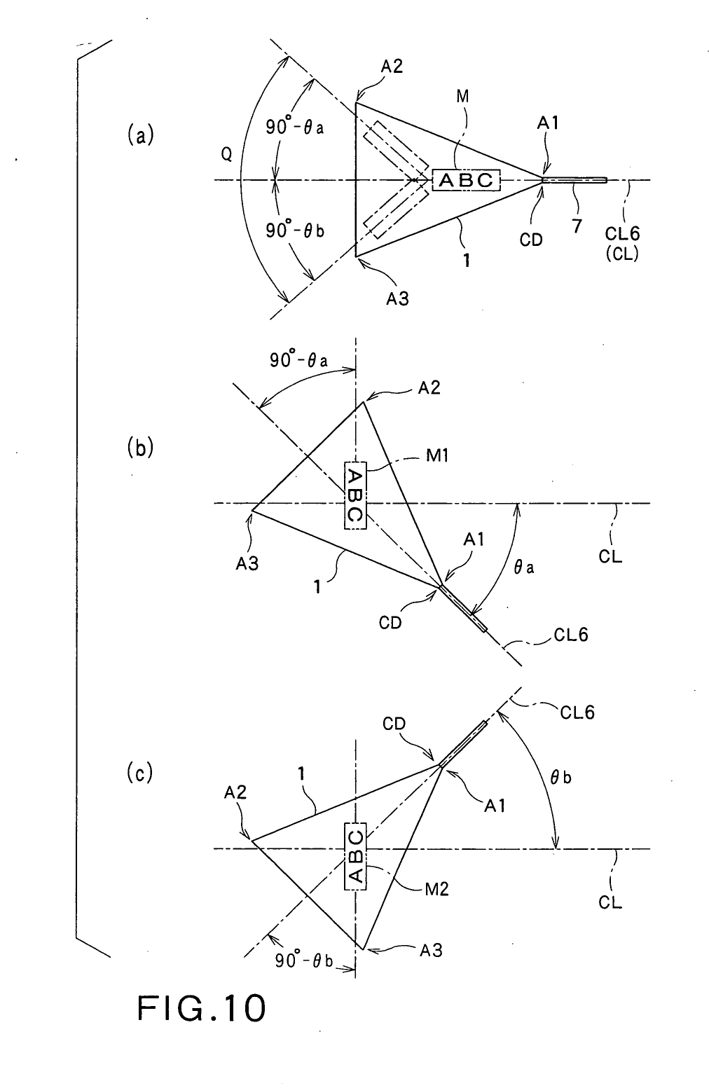

The displayed content M for the headphone 50 (50R) to be attached to the right ear is further described with reference to (a), (b) and (c) of FIG. 10.

Shown in (a), (b) and (c) of FIG. 10 in simplified form is the housing 1 of the headphone 50 (50R) to be attached to the right ear, with indication of the direction in which the cord 7 (2R) is running. In detail, shown in (a) of FIG. 10 is a posture of the housing 1 in which the cord 7 (2R) lying on an axis line CL6 runs in a direction of a horizontal line CL of the sheet of the drawing. Shown in (b) of FIG. 10 is another posture of the housing 1 in which the cord 7 (2R) lying on the axis line CL6 runs in a forward diagonally lower direction (or the clockwise direction) with an angle θa (such as, 60 degrees) with respect to the horizontal line CL, in the cord lower-running mode. Shown in (c) of FIG. 10 is still another posture of the housing 1 in which the cord 7 (2R) lying on the axis line CL6 runs in a forward diagonally upper direction (or the counterclockwise direction) with an angle θb (such as, 60 degrees) with respect to the horizontal line CL, in the cord upper-running mode.

In order for the displayed content M not to be upside down, the content M may be formed on the housing 1 as being inclined by an angle up to (90°−θa) in the clockwise direction from the axis line CL6 in the cord lower-running mode whereas up to (90°−θb) in the counterclockwise direction from the axis line CL6 in the cord upper-running mode. The displayed content M may thus be inclined within an angle range Q from (90°−θa) in the clockwise direction to (90°−θb) in the counterclockwise direction with respect to the axis line CL6, as shown in (a) of FIG. 10.

Shown in (b) of FIG. 10 is a displayed content M1 formed on the housing 1 as being inclined by the angle (90°−θa) in the clockwise direction from the axis line CL6. Shown in (c) of FIG. 10 is a displayed content M2 formed on the housing 1 as being inclined by the angle (90°−θb) in the counterclockwise direction from the axis line CL6.

In general, there are big differences in shape and size of ear among individuals. For this reason, there is a margin of shape for the headphone 50 and the stereo headphone 51 with an angle range for the angles θa and θb shown in FIGS. 9 and 10 in practical use.

The best angle for θa and θb is 60° in practical use. With the angle of 60° as the standard, the angles θa and θb may be set within a specific angle range, such as ±15°, that causes no problem in practical use, in the clockwise and counterclockwise directions.

It is further understood by those skilled in the art that the foregoing description is a preferred embodiment of the disclosed device and that various changes and modifications may be made in the invention without departing from the spirit and scope thereof.

For example, in the embodiment, the speaker unit 4 is provided at the tip of the sound-emitting portion 1b formed at the front side of the housing 1, as shown in FIG. 2. The speaker unit 4 may, however, be installed in the housing 1, as a modification.

The basic structural feature of the headphone 50 and the stereo headphone 51 in the embodiments is as follows:

The main body HT is equipped with the housing 1 and the cylindrical sound-emitting portion 1b provided at a first side of the housing 1 and to which the ear piece 6 is detachably attached, as shown in FIG. 2.

The speaker unit 4 is fixed to the sound-emitting portion 1b. However, the speaker unit 4 may be provided at the housing 1, for example, it can be installed in the housing 1, as described above.

The cord 7 runs outwardly from the cord guiding portion CD provided at the side face 1s (FIG. 2) of the housing 1 (the side face 1s being located between the first side and an opposing second side of the housing 1). The cord 7 may be covered with the bushing 8 to be guided to the outside of the housing 1.

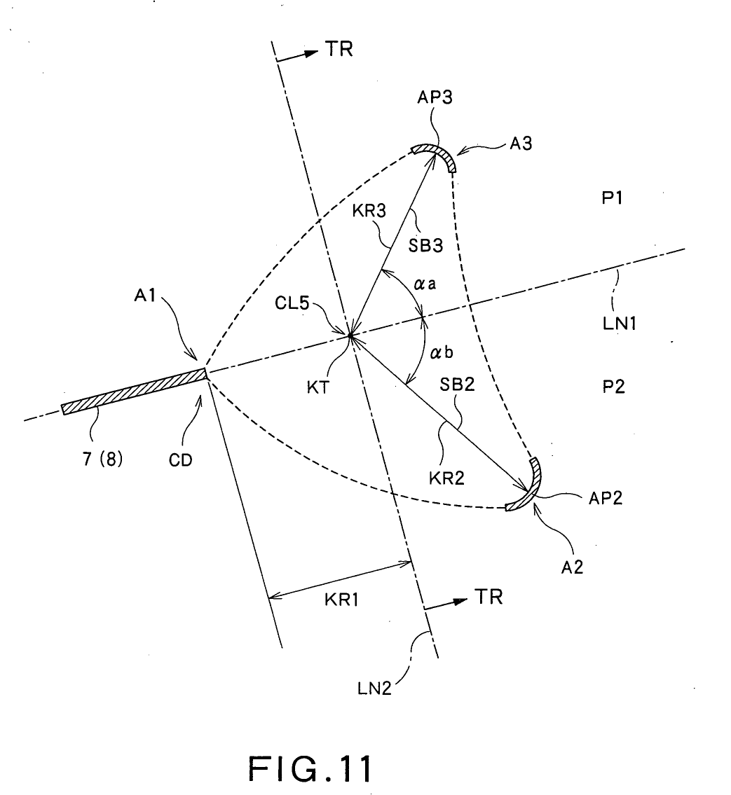

The basic structural feature is discussed further with reference to FIG. 11.

FIG. 11 shows the outer shape of the housing 1 in simplified form at the second side that is the opposite of the first side of the hosing 1 at which the sound-emitting portion 1b is provided, as described above.

Shown in FIG. 11 in simplified form is a cross section of the housing 1. The cross section is located at the second side (the opposite of the first side) of the hosing 1. The side face 1s (FIG. 2) is a side section of the housing 1, that is vertical to the cross section (FIG. 11) of the housing 1 and is extending between the first and second sides.

As shown in FIG. 11, the cord guiding portion CD is located at an outer edge of the cross section when the main body is viewed from the second side.

With respect to FIG. 11, the basic structural feature is discussed further as follows:

(A) When the main body HT is viewed from the second side, the opposite of the first side at which the sound-emitting portion 1b protrudes from the housing 1, the housing 1 is formed into a specific shape having at least a first summit (the summit A3 in FIG. 3) and a second summit (the summit A2 in FIG. 3) that are defined as follows:

The first summit A3 protrudes in a direction away from a point of intersection KT of the center axis line CL5 (that is horizontal to the sheet of FIG. 4 but vertical to the sheet of FIG. 11 and that goes through the sound-emitting portion 1b between the first and second sides and that is horizontal to the side section and vertical to the cross section) and a first straight line LN1 (that goes through the cord guiding portion CD in the cross section) in a third side (a side P1 in the cross section of FIG. 11) with respect to the first straight line LN1 and also in a fourth side (a side TR in the cross section of FIG. 11) that is far from (or the opposite of) the cord guiding portion CD with respect to a second straight line LN2 that goes through the point of intersection KT and intersects with the first straight line LN1

The second summit A2 protrudes in a direction away from the point of intersection KT in the fourth side (the side TR in FIG. 11) and also in a fifth side (a side P2 that is the opposite of the side P1 in FIG. 11) with respect to the first straight line LN1.

(B) Within the definition (A), the housing 1 is formed into a specific shape so that the first summit A3 or the second summit A2 is in contact with the inner wall ER1 of the concha E3 at the head rear side when the main body HT is fit in the concha E3 with the ear piece 6 (that is attached to the sound-emitting portion 1b) being inserted into the ear channel E5, as shown in FIG. 7.

(C) Within the definition (A) or (B), when the main body HT is viewed from the second side, a first distance KR3 from the point of intersection KT to a tip AP3 of the first summit A3 and a second distance KR2 from the point of intersection KT to a tip AP2 of the second summit A2 may be roughly equal to each other.

(D) Within the definition (A), (B) or (C), when the main body HT is viewed from the second side, a first angle αa between a first line segment SB3 (that connects the point of intersection KT and the tip AP3 of the first summit A3) and the first straight line LN1 and a second angle αb between a second line segment SB2 (that connects the point of intersection KT and the tip AP2 of the second summit A2) and the first straight line LN1 may be roughly equal to each other.

(E) Within the definition (C), when the main body HT is viewed from the second side, a third distance KR1 from the point of intersection KT to the cord guiding portion CD may be roughly equal to the first distance KR3 or the second distance KR2.

Moreover, when the main body HT is viewed from the second side, the displayed content M described with respect to FIGS. 9 and 10 is displayed on the cross section of the housing 1 (FIG. 11). The displayed content M is recognizable when the headphone 50 (or the stereo headphone 51) is attached to an ear of a user at least while the user sits or stands upright in a vertical direction so that the second straight line LN2 lies in the vertical direction.

As disclosed above in detail, the present invention provides the headphone and the stereo headphone available for both of the cord lower- and upper-running modes, having the main body which can be smoothly fit in the antihelix of a user's ear.

What is claimed is:

1. A headphone comprising:
a main body having a housing and a tube-like sound-emitting portion formed at a first section of the housing and to which an ear piece is detachably attached;
a speaker unit provided at the housing or the sound-emitting portion; and
a cord running outside from a cord guiding portion provided at a side section of the housing,
wherein, when the main body is viewed from a second section that is opposite of the first section, the housing has a first summit and a second summit,
the first summit protrudes in a first direction away from a point of intersection that is an intersection of a center axis line that goes through the sound-emitting portion and a first straight line that goes through the cord guiding portion and intersects with the center axis, the first direction being at one side with respect to the first straight line and another side far from the cord guiding portion with respect to a second straight line that goes through the point of intersection and is perpendicular to the first straight line, and
the second summit protrudes in a second direction away from the point of intersection, the second direction being at another side that is opposite of the one side with respect to the first straight line and another side far from the cord guiding portion with respect to the second straight line.

2. The headphone according to claim 1, wherein, when the headphone is attached to an ear of a user, the first or the second summit is in contact with an inner wall of a concha of the ear at a rear side of a head of the user when the main body is fit in the concha with the ear piece being inserted into an ear channel of the ear.

3. The headphone according to claim 1, when the main body is viewed from the second section, a first distance from the point of intersection to a tip of the first summit and a second distance from the point of intersection to a tip of the second summit is roughly equal to each other.

4. The headphone according to claim 1, when the main body is viewed from the second section, a first angle between a first line segment and the first straight line and a second angle between a second line segment and the first straight line are roughly equal to each other, wherein the first line segment connects the point of intersection and the tip of the first summit, and the second line segment connects the point of intersection and the tip of the second summit.

5. The headphone according to claim 3, when the main body is viewed from the second section, a third distance from the point of intersection to the cord guiding portion is roughly equal to the first or the second distance.

6. The headphone according to claim 1, when the main body is viewed from the second section, a mark is displayed on the cross section of the housing, wherein the mark is recognizable when the headphone is attached to an ear of a user at least while the user sits or stands upright in a vertical direction so that the second straight line lies in the vertical direction.

7. A headphone comprising:
a main body including a housing having a first side, an opposing second side, a cross section at the second side, and a side section that is vertical to the cross section and is extending between the first and second sides, the main body further including a sound-emitting portion provided at the first side and to which an ear piece is detachably attached, the sound-emitting portion having a center axis line that goes through the sound-emitting portion between the first and second sides and that is horizontal to the side section and vertical to the cross section;
a speaker unit provided at the housing or the sound-emitting portion; and
a cord guiding portion provided at the side section of the housing between the first and second sides and located at an outer edge of the cross section when the main body is viewed from the second side, a cord running outside of the housing from the cord guiding portion,
wherein, when the main body is viewed from the second side, the housing has at least a first summit and a second summit in the cross section, and the housing also has a point of intersection, a first straight line, and a second straight line, each being located in the cross section,
wherein, the point of intersection is an intersection of the center axis line and the first straight line that goes through the cord guiding portion in the cross section, and
the second straight line goes through the point of intersection and intersects with the first straight line,
wherein, the first summit protrudes in a direction away from the point of intersection in a third side that is located in the cross section with respect to the first straight line and also in a fourth side that is located in the cross section and is the opposite of the cord guiding portion with respect to the second straight line, and
the second summit protrudes in a direction away from the point of intersection in the fourth side and also in a fifth side that is located in the cross section and is the opposite of the third side with respect to the first straight line.

8. A stereo headphone comprising:
a first headphone to be attached to a left ear of a user; and
a second headphone to be attached to a right ear of the user,
wherein each of the first and second headphones includes;
a main body having a housing with a first side, an opposing second side, a cross section at the second side, and a side section that is vertical to the cross section and is extending between the first and second sides, the main body further having a sound-emitting portion provided at the first side and to which an ear piece is detachably attached, the sound-emitting portion having a center axis line that goes through the sound-emitting portion between the first and second sides and that is horizontal to the side section and vertical to the cross section;
a speaker unit provided at the housing or the sound-emitting portion; and
a cord guiding portion provided at the side section of the housing between the first and second sides and located at an outer edge of the cross section when the main body is viewed from the second side, a cord running outside of the housing from the cord guiding portion,
wherein, when the main body is viewed from the second side, the housing has at least a first summit and a second summit in the cross section, and the housing also has a point of intersection, a first straight line, and a second straight line; each being located in the cross section,
wherein, the point of intersection is an intersection of the center axis line and the first straight line that goes through the cord guiding portion in the cross section, and
the second straight line goes through the point of intersection and intersects with the first straight line,
wherein, the first summit protrudes in a direction away from the point of intersection in a third side that is located in the cross section with respect to the first straight line and also in a fourth side that is located in the cross section and is the opposite of the cord guiding portion with respect to the second straight line, and
the second summit protrudes in a direction away from the point of intersection in the fourth side and also in a fifth side that is located in the cross section and is the opposite of the third side with respect to the first straight line.

9. The stereo headphone according to claim 8, wherein, when the first or the second headphone is attached to the right or left ear, the first or the second summit is in contact with an inner wall of a concha of the ear at a rear side of a head of the user when the main body is fit in the concha with the ear piece being inserted into an ear channel of the ear.

10. The stereo headphone according to claim 8, when the main body is viewed from the second side, a first distance from the point of intersection to a tip of the first summit and a second distance from the point of intersection to a tip of the second summit is roughly equal to each other.

11. The stereo headphone according to claim 8, when the main body is viewed from the second side, a first angle between a first line segment and the first straight line and a second angle between a second line segment and the first straight line are roughly equal to each other, wherein the first line segment connects the point of intersection and the tip of the first summit, and the second line segment connects the point of intersection and the tip of the second summit.

12. The stereo headphone according to claim 10, when the main body is viewed from the second side, a third distance from the point of intersection to the cord guiding portion is roughly equal to the first or the second distance.

13. The stereo headphone according to claim 8, when the main body is viewed from the second side, a mark is displayed on the cross section of the housing, wherein the mark is recognizable when the first or the second headphone is attached to the left or right ear at least while the user sits or stands upright in a vertical direction so that the second straight line lies in the vertical direction.
